(19) United States
(12) Patent Application Publication
(10) Pub. No.: US 2004/0075719 A1
(43) Pub. Date: Apr. 22, 2004

(54) Inkjet pen and manufacturing method thereof

(76) Inventors: Cheng-Wei Hsu, Tainan Hsien (TW); Bo-Hsiang Wang, Taiping City (TW); I-Chung Hou, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/355,930

(22) Filed: Jan. 31, 2003

(30) Foreign Application Priority Data
Oct. 18, 2002 (TW) 91124091

(51) Int. Cl. B41J 2/175

(52) U.S. Cl. 347/86

(57) ABSTRACT

An inkjet pen and a manufacturing method thereof. The inkjet pen includes a body, a side plate, an elastic member, and a dividing plate. The side plate is combined with the body. The elastic member is disposed in the body. The dividing plate is disposed in the body in a manner such that the dividing plate abuts the elastic member. A gap is formed between the dividing plate and the side plate.

### BACKGROUND OF THE INVENTION

1. Field of the Invention

The invention relates to an inkjet pen and a manufacturing method thereof; in particular an inkjet pen with enhanced assembly yield and reduced assembly time.

2. Description of the Related Art

Assembly of inkjet pens can be substantially divided into two types. In one, components are disposed in the inkjet pen in a vertical orientation. The other type disposes components in a horizontal orientation. Since the invention is designed based on the latter, the description of the former is omitted.

In the conventional inkjet pen that is assembled in a horizontal orientation, a bag, a pressure plate, and a spring are located in a body of the inkjet pen by a side plate. During assembly, the bag is first disposed in the body. Second, the spring and the pressure plate are combined together and disposed in the body. Then, the spring is completely pressed into the body by the side plate. Finally, the side plate is fixed on the body by ultrasonic or vibration welding.

However, in the conventional inkjet pen, when the side plate is fixed on the body, the side plate cannot be properly positioned due to the force of the spring. Specifically, since the side plate directly abuts the spring, the position of the side plate may be affected by the spring. As a result, the side plate may not be properly fixed on the body.

### SUMMARY OF THE INVENTION

In view of this, the invention provides an inkjet pen and a manufacturing method thereof such that assembly yield is enhanced and assembly time is reduced.

Accordingly, the invention provides an inkjet pen. The inkjet pen includes a body, a side plate, an elastic member, and a dividing plate. The side plate is combined with the body. The elastic member is disposed in the body. The dividing plate is disposed in the body in a manner such that the dividing plate abuts the elastic member. A gap is formed between the dividing plate and the side plate.

In a preferred embodiment, the dividing plate is fixed in a predetermined position in the body by pressure fitting so that the gap is maintained between the dividing plate and the side plate.

In another preferred embodiment, the dividing plate includes a plurality of protrusions abutting the body.

It is understood that the elastic member may be a spring.

In another preferred embodiment, the inkjet pen further includes a bag and a pressure plate. The bag is disposed in the body, and communicates with the external environment so as to expand inside the body. The pressure plate is disposed in the body in a manner such that the pressure plate is located adjacent to the bag and the elastic member so as to move in the body.

The invention also provides a method for manufacturing an inkjet pen. The method includes the following steps. First, a body, an elastic member, a dividing plate, and a side plate are provided. Second, the elastic member is disposed on the dividing plate, and the dividing plate, along with the elastic member, are disposed in a predetermined position in the body. Then, the side plate is disposed on the body in a manner such that a gap is formed between the side plate and the dividing plate so that the side plate does not directly abut the elastic member. Finally, the side plate is fixed on the body.

In a preferred embodiment, the side plate is fixed on the body by ultrasonic or vibration welding or adhesion.

In another preferred embodiment, the dividing plate is fixed in the predetermined position in the body by pressure fitting.

In another preferred embodiment, the method further includes the following steps. A bag and a pressure plate are provided, and the bag and the pressure plate are disposed in the body before the dividing plate is disposed in the body. It is noted that the pressure plate abuts the elastic member.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an exploded schematic view of an inkjet pen as disclosed in the invention;

FIG. 2 is a cross section of the assembled inkjet pen in FIG. 1; and

FIG. 3 is a cross section along a line c-c in FIG. 2.

### DETAILED DESCRIPTION OF THE INVENTION

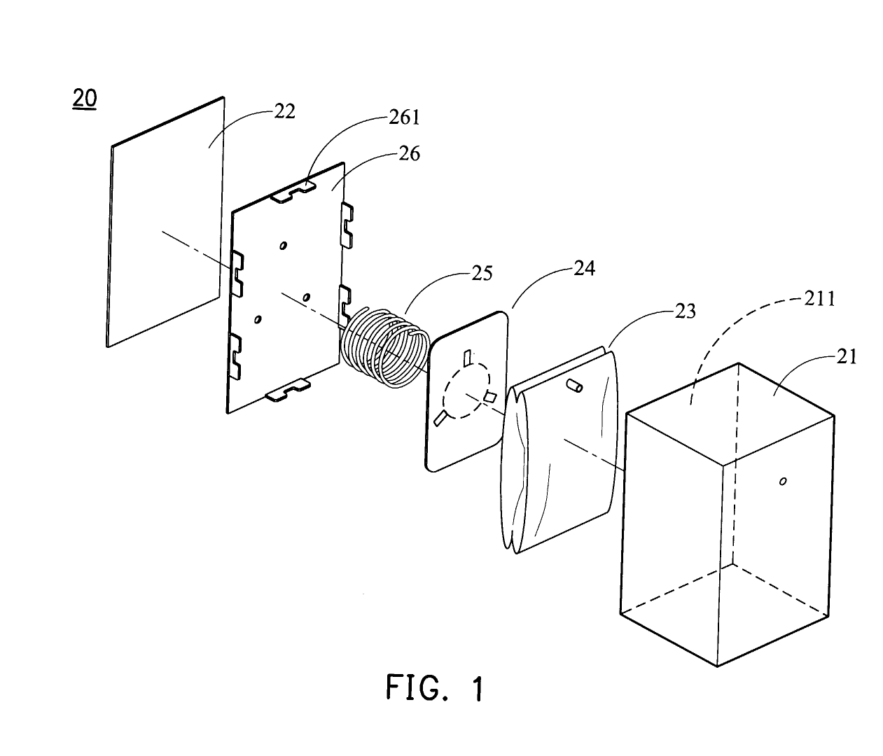

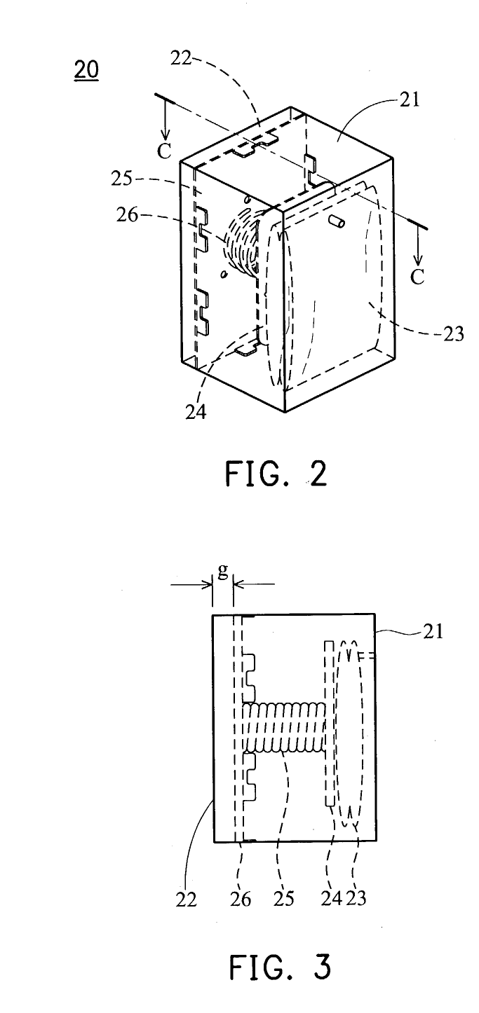

Referring to FIG. 1 and FIG. 2, an inkjet pen 20 as disclosed in the invention is shown. The inkjet pen 20 includes a body 21, a side plate 22, a bag 23, an elastic member 25, and a dividing plate 26.

The body 21 is a basic component of the inkjet pen 20, and includes an opening 211 at one side so that other components can be placed in the body 21. The side plate 22 is combined with the body 21 at the side, forming the opening 211, of the body 21. After the side plate 22 is combined with the body 21, the bag 23, the elastic member 25, and the dividing plate 26 are sealed in the body 21 by the side plate 22.

The bag 23 is disposed in the body 21, and communicates with the external environment 21 so as to expand inside the body 21.

In a preferred embodiment, the inkjet pen 20 further includes a pressure plate 24. The pressure plate 24 is disposed in the body 21 adjacent to the bag 23 and the elastic member 25 so as to move in the body 21. The elastic member 25 is disposed in the body 21 adjacent to the pressure plate 24 and the dividing plate 26. It is understood that the elastic member 25 may be a spring. Furthermore, the bag 23, the pressure plate 24, and the elastic member 25 constitute a back-pressure adjustment mechanism of the inkjet pen 20.

The dividing plate 26 is disposed in the body 21 abutting the elastic member 25. The dividing plate 26 includes a plurality of protrusions 261 at its periphery. Each of the protrusions 261 is provided with certain elasticity. Thus, when the dividing plate 26 is disposed in the body 21, it is maintained in a predetermined position in the body 21 by the protrusions 261 abutting the body 21. As a result, the dividing plate 26 is fixed in the predetermined position in the body 21 by pressure fitting so that a gap g is formed between the dividing plate 26 and the side plate 22 as shown in FIG. 3.

It is understood that the structure and the number of the protrusions 261 are not limited as long as the dividing plate 26 can be properly maintained in the predetermined position in the body 21.

The structure of the inkjet pen 20 of the invention is stated as above, and the manufacturing method thereof is described as follows.

First, the bag 23 is disposed in the body 21. Second, the elastic member 25 is combined with the pressure plate 24 and the dividing plate 26 at two ends, and all are disposed in the body 21. At this time, by the protrusions 261, the dividing plate 26 is fixed in the predetermined position in the body 21 by pressure fitting. Also, the pressure plate 24 abuts the bag 23. Then, the side plate 22 is disposed on the side, forming the opening 211, of the body 21 in a manner such that the gap g is maintained between the side plate 22 and the dividing plate 26 so that the side plate 22 does not directly abut the elastic member 25. Finally, the side plate 22 is fixed on the body, 21 by ultrasonic or vibration welding or adhesion.

By adding the dividing plate 26 to fix the elastic member 25, the side plate 22 does not directly abut the elastic member 25 during assembly. Thus, the side plate 22 can be properly fixed on the body 21. As a result, the assembly yield of the inkjet pen can be enhanced, and the assembly time thereof can be reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. An inkjet pen comprising:
a body;
a bag, disposed in the body, communicating with the external environment so as to expand inside the body;
a side plate combined with the body;
an elastic member disposed in the body; and
a dividing plate disposed in the body abutting the elastic member, wherein a gap is formed between the dividing plate and the side plate.

2. The inkjet pen as claimed in claim 1, wherein the dividing plate is fixed in a predetermined position in the body by pressure fitting so that the gap is maintained between the dividing plate and the side plate.

3. The inkjet pen as claimed in claim 1, wherein the dividing plate includes a plurality of protrusions abutting the body.

4. The inkjet pen as claimed in claim 1, wherein the elastic member is a spring.

5. The inkjet pen as claimed in claim 1, further comprising:
a pressure plate disposed in the body in a manner such that the pressure plate is located adjacent to the bag and the elastic member so as to move in the body.

6. A method for manufacturing an inkjet pen, comprising:
providing a body, an elastic member, a dividing plate, and a side plate;
providing a bag and disposing the bag in the body;
disposing the elastic member on the dividing plate;
disposing the dividing plate with the elastic member in a predetermined position in the body;
disposing the side plate on the body in a manner such that a gap is formed between the side plate and the dividing plate so that the side plate does not directly abut the elastic member; and
fixing the side plate on the body.

7. The method as claimed in claim 6, wherein the side plate is fixed on the body by ultrasonic welding.

8. The method as claimed in claim 6, wherein the side plate is fixed on the body by vibration welding.

9. The method as claimed in claim 6, wherein the side plate is fixed on the body by adhesion.

10. The method as claimed in claim 6, wherein the dividing plate is fixed in the predetermined position in the body by pressure fitting.

11. The method as claimed in claim 6, further comprising:
providing a pressure plate and disposing the pressure plate in the body before disposing the dividing plate in the body, such that the pressure plate abuts the elastic member.
